(19) United States
(12) Patent Application Publication
(10) Pub. No.: US 2016/0060864 A1
(43) Pub. Date: Mar. 3, 2016

(54) PANEL FOR WALLS, CEILINGS, FALSE CEILINGS, FLOOR SURFACES, FURNISHING ELEMENTS AND THE LIKE

(71) Applicant: MASCAGNI S.P.A., Casalecchio di Reno (IT)

(72) Inventor: Antonio MUGNOZ, Trevi (IT)

(73) Assignee: MASCAGNI S.P.A., Casalecchio di Reno (IT)

(21) Appl. No.: 14/636,302

(22) Filed: Mar. 3, 2015

(30) Foreign Application Priority Data
Aug. 29, 2014 (EP) 14425110.5

(51) Int. Cl. E04B 1/88; B32B 9/02; B32B 7/12; B32B 27/08; B32B 27/36; B32B 3/26; B32B 21/08; B32B 27/12

(52) U.S. Cl. CPC E04B 1/88; B32B 21/08; B32B 9/02; B32B 27/12; B32B 27/08; B32B 27/36; B32B 3/266; B32B 7/12; B32B 2607/00; B32B 2419/00; B32B 2307/304; B32B 2307/102; B32B 2307/72

(57) ABSTRACT

A panel for walls, ceilings, false ceilings, floor surfaces, and furnishing elements, comprising at least one continuous insulating layer of polymeric material coupled stably to at least one sheet of a material preferably selected from among wood, polymeric material, fabric, microfiber, hide and the like.

The present invention relates to a panel for walls, ceilings, false ceilings, floor surfaces, furnishing elements and the like.

As is known, noise pollution is generally caused by excessive exposure to sounds and noise of such high intensity as to cause annoyance or disturb rest and human activity, even representing a danger to human health.

In fact, over time noise pollution can cause people psychological pressure and stress problems.

Such phenomenon can be found both in outside environments owing to construction sites, airports, motorways, motor racing tracks, and also in indoor environments, in particular in public environments such as offices, bars, restaurants, swimming pools, gyms and the like.

It is known that in order to be able to limit noise pollution one can soundproof the buildings with the use of particular construction materials and techniques.

Frequently, use is made of noise barriers, generally constituted by walls, panels and the like, of limited height, which are provided with sound insulation or sound absorption capacity, and are arranged between the source of the noise and the affected area.

These are passive methods of reducing noise, and are geared to present obstacles to the propagation of noise.

One of the principal drawbacks of noise barriers is represented by their appearance, which in the majority of cases is unpleasant or in any case difficult to adapt to the requirements of architects, designers and furnishers, who need to design an environment following a certain style, aesthetic requirements or tastes of the purchaser.

In fact, in the provision of such barriers there is an extremely low level of customization of materials, colors, surfaces and shapes.

The aim of the present invention is to solve the above mentioned drawbacks, by providing a panel for walls, ceilings, false ceilings, floor surfaces, furnishing elements and the like which has a high degree of customization.

Within this aim, an object of the invention is to provide a panel for walls, ceilings, false ceilings, floor surfaces, furnishing elements and the like which makes it possible to optimize the acoustics in the environments in which it is installed.

Another object of the present invention is to provide a panel for walls, ceilings, false ceilings, floor surfaces, furnishing elements and the like which makes it possible to reduce noise pollution in the environments in which it is installed.

Another object of the present invention is to provide a panel for walls, ceilings, false ceilings, floor surfaces, furnishing elements and the like which is low cost, easily and practically implemented, and safe in use.

This aim and these and other objects which will become better apparent hereinafter are achieved by a panel for walls, ceilings, false ceilings, floor surfaces, furnishing elements and the like, characterized in that it comprises at least one continuous insulating layer of polymeric material coupled stably to at least one sheet of a material preferably selected from among wood, polymeric material, fabric, microfiber, hide and the like.

Further characteristics and advantages of the invention will become better apparent from the description of a preferred, but not exclusive, embodiment of the panel for walls, ceilings, false ceilings, floor surfaces, furnishing elements and the like, according to the invention, which is illustrated by way of non-limiting example in the accompanying drawings wherein:

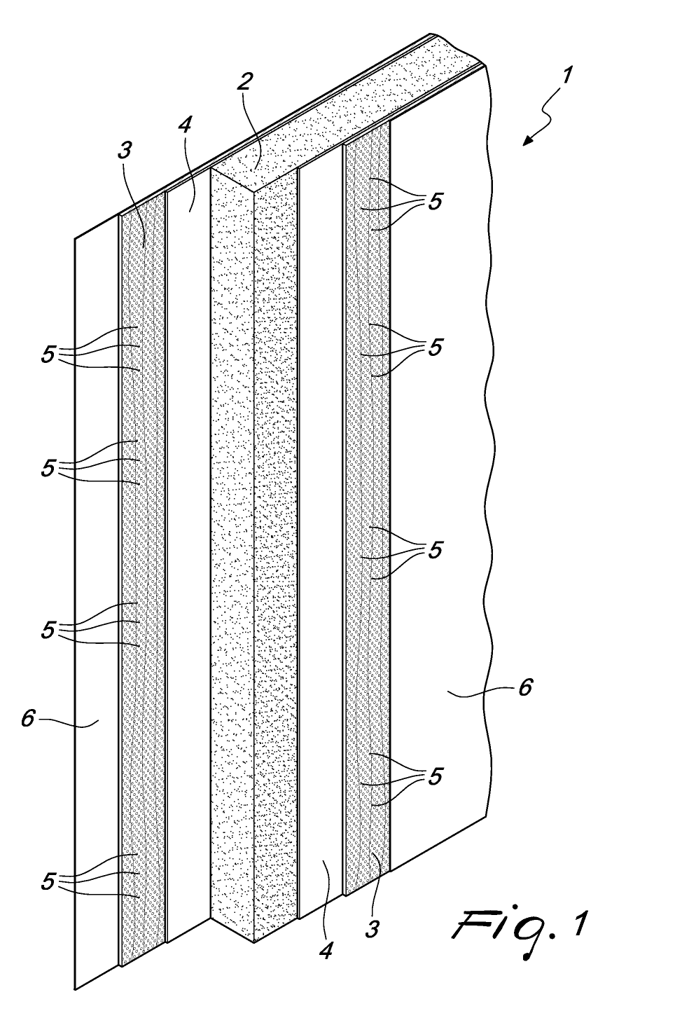

FIG. 1 is a partially sectional perspective view of the panel according to the invention;

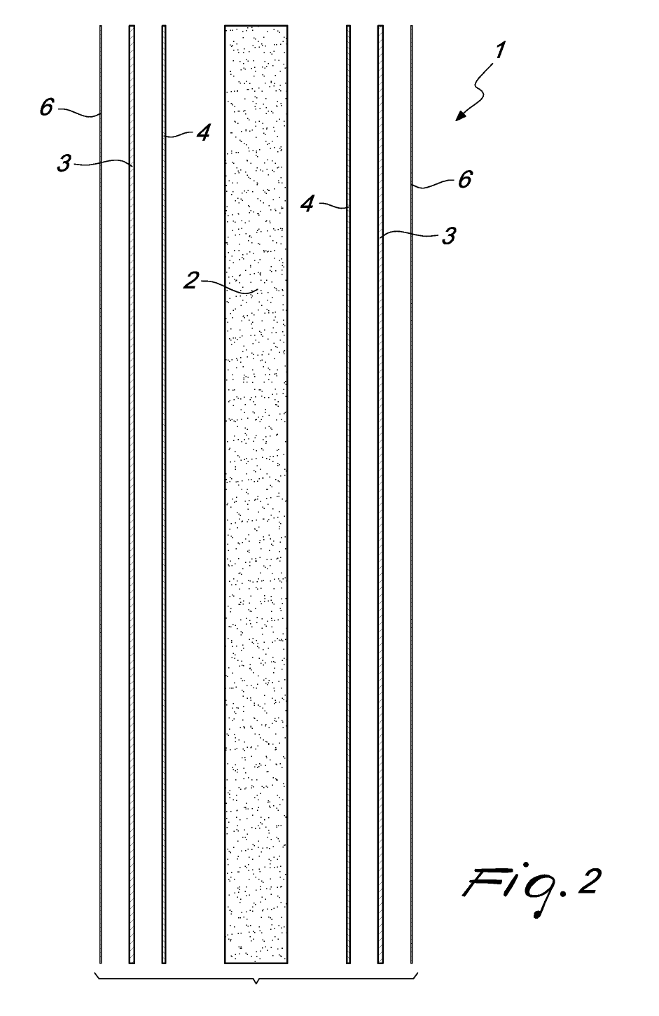

FIG. 2 is an exploded front elevation view of the panel according to the invention according to a possible embodiment;

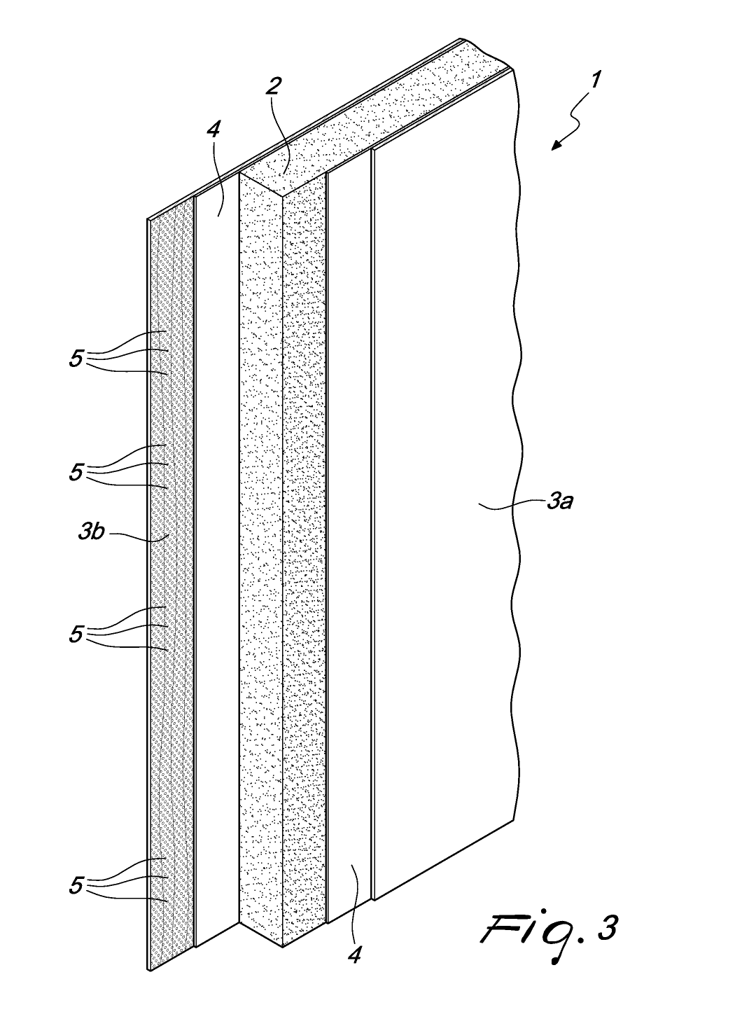

FIG. 3 is a partially sectional perspective view of the panel according to the invention, according to a different possible embodiment.

With reference to the figures, the reference numeral 1 generally designates a panel for walls, ceilings, false ceilings, floor surfaces, furnishing elements and the like.

The panel 1 comprises at least one continuous insulating layer 2 of polymeric material coupled stably to at least one sheet 3 of a material preferably selected from among wood, polymeric material, fabric, microfiber, hide and the like.

The appropriate combination of the materials that constitute the continuous layer 2 and the sheet 3, by taking advantage of different mechanisms, enables an optimal absorption of sound energy.

Furthermore, the presence of the sheet 3 renders the layer 2 externally invisible, thus making possible a high degree of customization of the panel 1.

In fact, the possibility of making the sheet 3 from materials of different types, without interfering with the sound absorption capacities of the panel 1, makes it possible to meet the design requirements of designers, architects, furnishers and the like.

In particular, the continuous layer 2 can be constituted by polyester for thermal and/or acoustic insulation.

Polyester is particularly suitable for this embodiment, in that it is a material with an open porous structure that ensures an optimal dissipation of sound energy.

In fact, in porous materials, sound absorption is provided by viscous dissipation of the mechanical energy of the sound wave as heat, i.e. by phenomena of friction in the porosity of the material.

According to a solution of particular utility and practicality, shown in the accompanying figures, a film 4 of adhesive material can be interposed between the continuous layer 2 and the sheet 3.

The sheet 3 can thus be glued to the layer 2, thus taking on the same shape as the layer 2 proper.

The at least one sheet 3 can have a plurality of through openings 5 that are distributed in order to increase the capacity of the sheet 3 for the transmission of sound waves to the continuous layer 2.

The sound energy is thus further dissipated by a phenomenon of damping of the oscillation of the air mass, which is partially confined in the opening 5 and is made to vibrate by the sound waves striking the opening 5 proper.

The presence of the sheet 3 thus makes it possible to boost the sound-absorption properties of the continuous layer 2.

The openings 5 can be mutually arranged on the sheet 3 according to a plurality of different preset configurations.

The openings 5 can have a diameter of size comprised between 0.001 mm and 100 mm.

The sheet 3 can be perforated by defining openings 5 which can have different diameters and configurations according to the requirements of architects, designers, furnishers and the like.

The possibility is not excluded of providing openings 5 of different diameters on the same panel 1; it is in fact possible to achieve an absorption distributed over a broader frequency range, by using panels with openings 5 of different diameters.

The panel 1 can have a second, continuous sheet 6 coupled to the first, perforated sheet 3, covering it in order to prevent its openings 5 from being seen.

The continuous layer 2, as illustrated in FIG. 3, can be interposed between two sheets 3a and 3b, with optional interposition of the film of adhesive material 4, one 3a of the sheets being of fabric, the other 3b of the sheets being of wood.

Thus it is possible to provide the sheet 3 using materials of different types such as wood or fabric, ductile materials with high aesthetic impact.

The panel 1 is thus extremely light, space-saving and adaptable to all types of environments, both public environments like bars, restaurants, cinemas, theaters, offices, airports, shopping centers, swimming pools, gyms, and also private and residential environments.

The continuous layer 2 can have a density that is preferably selected between 5 kg/m3 and 120 kg/m3.

The extent of the absorption depends in fact on the structure and on the density of the layer 2 used for providing the panel 1.

A higher density of the layer 2 makes it possible to provide panels 1 that are substantially rigid, while a lower density makes it possible to obtain a panel 1 that can be easily folded in order to adapt it to the various different requirements of architects, designers, furnishers and the like.

The continuous layer 2 can have a thickness that is preferably selected between 1 mm and 200 mm.

The extent of the absorption also depends on the thickness of the layer 2 used to provide the panel 1; greater thickness implies greater capacity to absorb sound energy.

The sheet 3 can have a thickness that is preferably selected between 0.1 mm and 10 mm.

The extent of the absorption also depends on the type of material used to provide the sheet 3 and in particular on its thickness; greater thickness implies a greater capacity to absorb sound energy.

The panel 1 is substantially modular, and can be provided according to different shapes and sizes, according to requirements.

Furthermore, it can be coupled to other panels 1, in order to provide different types of products, such as walls, partitions, ceilings, false ceilings, floor surfaces, furnishing elements and the like.

The possibility is not excluded of using the panels 1, according to the invention, in order to cover the walls, for example, of a recording studio, or of a cinema or of a theater, where acoustics plays a critical role.

Effectively, the panel 1 for walls, ceilings, false ceilings, floor surfaces, furnishing elements and the like enables a high degree of customization and therefore makes it possible to meet the various and particular requirements of architects, designers, furnishers and the like. Advantageously, the panel 1 for walls, ceilings, false ceilings, floor surfaces, furnishing elements and the like makes it possible to optimize the acoustics in the environments in which it is installed.

Conveniently, the panel 1, according to the invention, makes it possible to reduce noise pollution in the environments in which it is installed.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in EPA No. 14425110.5 from which this application claims priority are incorporated herein by reference.

1. A panel for walls, ceilings, false ceilings, floor surfaces and furnishing elements, comprising:
a continuous insulating layer of polyester for at least one of thermal insulation and acoustic insulation, which is coupled stably to at least one sheet of a material selected from the group consisting of wood, polymeric material, fabric, microfiber and hide, wherein a film of adhesive material is interposed between said continuous layer and said sheet, wherein said sheet has a plurality of through openings that are distributed in order to increase the capacity of said sheet for the transmission of sound waves to said continuous layer, wherein said openings have a diameter comprised between 0.001 mm and 100 mm, wherein said continuous layer has a density between 5 kg/m³ and 120 kg/m³, wherein said continuous layer has a thickness between 1 mm and 200 mm, and wherein said sheet has a thickness between 0.1 mm and 10 mm.

2.-4. (canceled)

5. The panel according to claim 1, wherein said openings are mutually arranged on said sheet according to a plurality of different preset configurations.

6. (canceled)

7. The panel according to claim 1, wherein said continuous layer is interposed between two sheets, with interposition of the film of adhesive material, one of said sheets being of fabric, the other of said sheets being of wood.

8.-10. (canceled)

11. The panel according to claim 1, wherein the continuous insulating layer is in contact with the adhesive material and the adhesive material is in contact with the sheet.
